(19) United States
(12) Patent Application Publication
(10) Pub. No.: US 2009/0185489 A1
(43) Pub. Date: Jul. 23, 2009

(54) Scheduling the transmission of messages on a broadcast channel of an ad-hoc network dependent on the usage of this channel

(76) Inventors: Marco Ruffini, Dublin (IE); Andries Van Wageningen, Wijlre (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/658,226

(22) PCT Filed: Jul. 18, 2005
(86) PCT No.: PCT/IB2005/052387

§ 371 Date: Mar. 10, 2009

(30) Foreign Application Priority Data
Jul. 22, 2004 (EP) 04103516.3

(51) Int. Cl. G08C 15/00; H04L 12/28

(52) U.S. Cl. 370/237; 370/400

(57) ABSTRACT

In order to provide a communication system (100) as well as a method of communication between and among mobile nodes (10, 12, 14, 16), in particular between and among vehicles, with each node (10, 12, 14, 16) sending at least one message (24, 26) via at least one broadcast channel (18) and receiving at least one arriving message (34, 36) being sent by at least one neighboring node (12, 14, 16) via the broadcast channel (18), wherein the access to the broadcast channel (18) is regulated, a certain equity in the bandwidth subdivision is guaranteed and network overloading is prevented, it is proposed that the transmission of the messages (24, 26) is scheduled dependent on the usage of the broadcast channel (18), in particular dependent on the load of the broadcast channel (18), the S[ignal]/N[oise] ratio on the broadcast channel (18), and/or the contents and/or type of messages (34, 36) received via the broadcast channel (18).

In general, the present invention relates to the problem of medium access control (MAC) for an ad hoc wireless network, which is generally a top priority issue in all wireless networks and is especially important in automotive or car-to-car communication, where the system reliability is the most important characteristic.

In particular, the present invention relates to a communication system for and a method of communication between and among mobile nodes, in particular between and among vehicles, with each node

sending at least one message via at least one broadcast channel and

receiving at least one arriving message being sent by at least one neighboring node via the broadcast channel.

One of the most important characteristics of a car-to-car communication system is complete reliability and operability in every condition where it has to be completely decentralized. In fact, the number of nodes and their mobility can vary within a very wide interval. To maintain the stability of the network without any central controller implies

that each node has to operate in a reliable way, guaranteeing the required performance and

that all the algorithms employed are working in a fully distributed fashion.

Usually in the road environment dangerous situations occur when many cars are close to each other; coincidentally, this is also the situation in which the transmission channel can easily become overloaded and more and more unusable because of packet collisions. In fact, the most important problem of channel overloading is that the throughput of the network can decrease to unacceptably low levels.

If such a situation occurs, there is a danger the network can no longer support the exchange of important information; moreover, the network can remain congested for an undetermined time.

One of the most widespread wireless network standards, the IEEE 802.11 WLAN standard, proposes a mechanism called C[arrier]S[ense]M[ultiple]A[ccess]/C[ollision]A[voidance] to avoid packet collision, in which every node senses the transmitting medium and tries to access the transmission channel after having waited a random time from the moment that the medium is sensed free. This CSMA/CA mechanism works well when the network load is not excessive, while under overload conditions the throughput decreases to unacceptable levels, mainly due to the so-called hidden node problem.

Many solutions have been proposed to tackle this hidden node problem: For example, prior art document US 2003/0109261 A1 proposes a system which adapts the transmission rate in dependence on the channel conditions. In prior art document US 2003/0078006 A1, adaptive modulations and encoding is introduced, while in prior art document EP 1 326 463 A1, a power control mechanism is used to increase the performance of a C[ode]D[ivision]M[ultiple]A[ccess] network.

A well-known approach is to decrease the number of messages sent by each node. A solution of this kind is proposed in prior art document WO 03/041345 A1, where the proposal is to vary the number of packets transmitted in dependence on the delivery success of the previously transmitted messages. Similarly, it is proposed in prior art document WO 03/015355 A2 to decrease the number of packets transmitted in dependence on a feedback based on the packet loss. Specifically, the idea is to decrease the number of messages sent if the system senses the channel to be congested, where congestion is measured on the basis of the number of packets lost.

This kind of approach cannot be used to improve the performance of a system mainly based on broadcast messages, like a car-to-car communication system. For broadcast messages the delivery success cannot be measured, so it becomes important to make use of other means to measure the channel quality.

Starting from the disadvantages and shortcomings as described above and taking the prior art as discussed into account, an object of the present invention is to provide a communication system as well as a method of communication, wherein the access to the broadcast channel is regulated, a certain equity in the bandwidth subdivision is guaranteed and network overloading is prevented.

The object of the present invention is achieved by a communication system comprising the features of claim 1 as well as by a method comprising the features of claim 7. Advantageous embodiments and expedient improvements of the present invention are disclosed in the respective dependent claims.

Hence the present invention is principally based on the idea of transmission channel (or broadcast channel) measurement for message handling as well as for node rate messaging control, and in particular on the idea of optimizing the present communication system (or connectivity system) on a M[edium]A[ccess]C[ontrol] extension and application level beyond the physical layer, contrary to the approaches as described in the prior art.

According to the present invention, a mechanism is proposed that continuously regulates the rate at which each node is allowed to generate messages, depending on relevant information provided from different sources, like the S[ignal]/N[oise] ratio and/or the load condition of the broadcast channel (or transmission channel).

Accordingly, the mechanism introduced is not just an anti-congestion mechanism, but rather a way to equally subdivide the available bandwidth as extension to IEEE 802.11. This is particularly important for car-to-car communication, where every car needs guaranteed access to send its periodical alert “Hello” messages. The proposed mechanism anyway also prevents congestion of the system.

Compared to the prior art as discussed above, the main difference of the present invention is that the information is retrieved that is required to regulate the message rate imposing a limit on the usable bandwidth (for each node) by sensing directly the S[ignal]/N[oise] ratio and the load condition of the channel. Also, the type of messages that are received is analyzed and the number of neighbor cars is calculated, especially by means of the “Hello” messages received.

According to a preferred embodiment of the present invention, other relevant information received from external warning messages is included. To be more specific in the usage of the allowed bandwidth at each node, a partition in three sub-rates for three basic types of messages used is proposed.

Moreover, in order to make the present communication system more flexible, the implementation of a mechanism is suggested that allows one node to ask the other nodes to dispose of bandwidth in case of necessity. This concept was already proposed in Bangnan Xu, “Self-organizing wireless broadband multihop networks with QoS guarantee”, Aachener Beiträge zur Mobil-und Telekommunikation, Band 32, September 2002; compared to this prior art article, an important improvement is introduced, which consists of a mechanism that gradually restores the normal functionality of the network after each request for more bandwidth.

The present invention finally relates to the use of a communication system as described above and/or the use of the method as described above for wireless ad hoc networks, in particular for automotive or car-to-car communication, wherein cars interact cooperatively and distribute for example warning messages, especially

in order to avoid collisions during lane change or merge manoeuvres and

for reporting of invisible obstacles, for example obscured or shadowed objects, when vehicles are moving in different directions within the same area.

For such exemplary applications, the present invention is meant to provide general rules to make a wireless self-organized network able to maintain its correct functionality even under adverse traffic conditions. So it should be implemented as a basic part of the protocol, extending the M[edium]A[ccess]C[ontrol] and influencing the application layers.

With the present invention, the available bandwidth is better exploited: in fact, if there are few cars within a certain range, every car is allowed to transmit more data and to exchange information that is not strictly related to safety. On the other hand, if there are many cars around, then the system assures that every node can specify its position with a certain rate and is able to send warning messages, if required by the situation.

All in all, the present invention solves one of the problems of medium access control in a wireless ad hoc network for car-to-car communication. Since the idea is to have a completely decentralized organization, there is no central controller that can regulate the access to the medium, partition the available bandwidth in the proper way among the nodes and prevent deleterious overloading of the channel.

The present invention gives some rules in the form of algorithms that each node should follow to improve the network performance in every situation: from the case when few nodes are transmitting, and thus are allowed to exchange a big quantity of data, to the case when a lot of nodes need to transmit, and thus are allowed to send only the most relevant information. Here the importance of the mechanism according to the present invention becomes obvious: it regulates the access to the broadcast or transmission channel, it guarantees certain equity in the bandwidth subdivision and it prevents network overloading, especially in high traffic load situations.

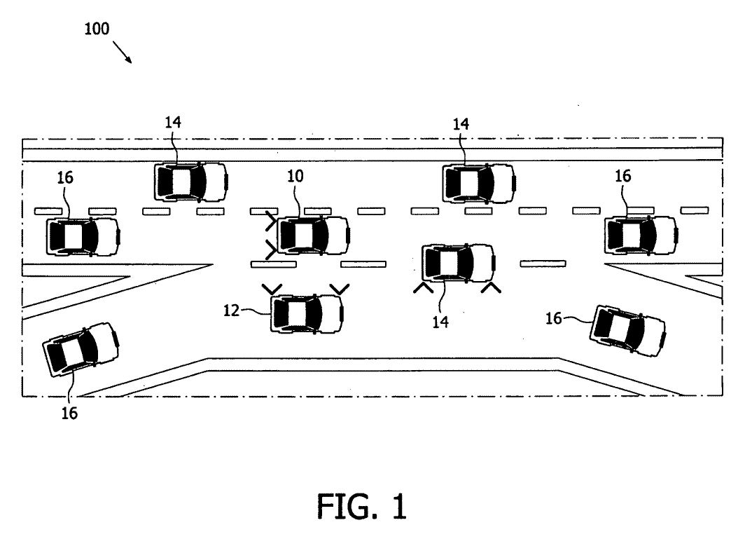

As already discussed above, there are several options to embody as well as to improve the teaching of the present invention in an advantageous manner. To this aim, reference is made to the claims dependent on claim 1 and claim 7; further improvements, features and advantages of the present invention are explained hereinbelow by way of example only with reference to a preferred embodiment (cf. FIG. 1 to FIG. 5) and to the accompanying drawings, where

FIG. 1 schematically shows an embodiment of a communication system according to the present invention being operated according to the method of the present invention;

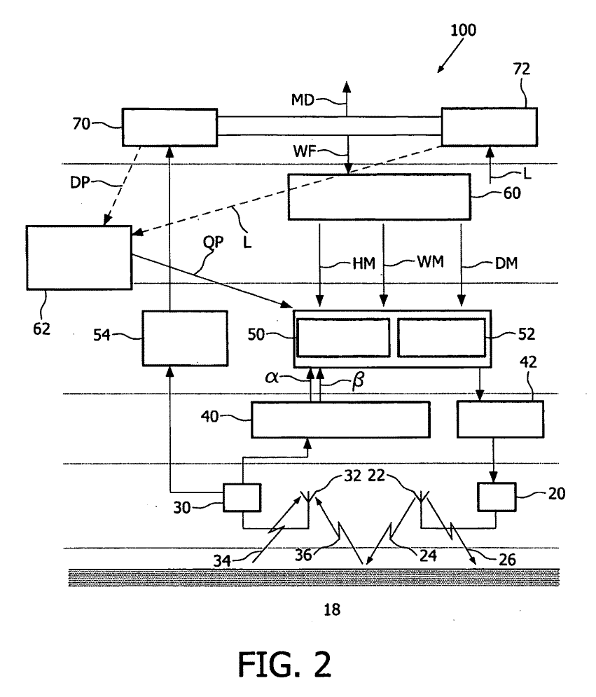

FIG. 2 schematically shows in more detail the system architecture for the communication system of FIG. 1;

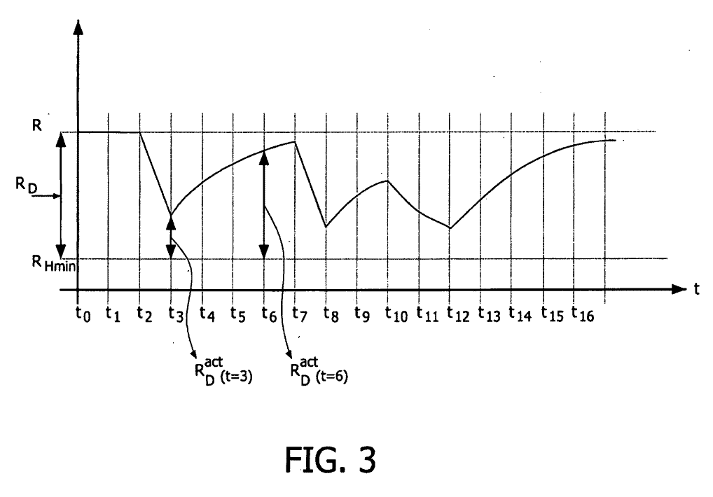

FIG. 3 schematically shows a timing diagram (——>time t on the abscissa) of the mechanism of bandwidth restoration, i.e. of freeing and reoccupying the bandwidth R on the ordinate;

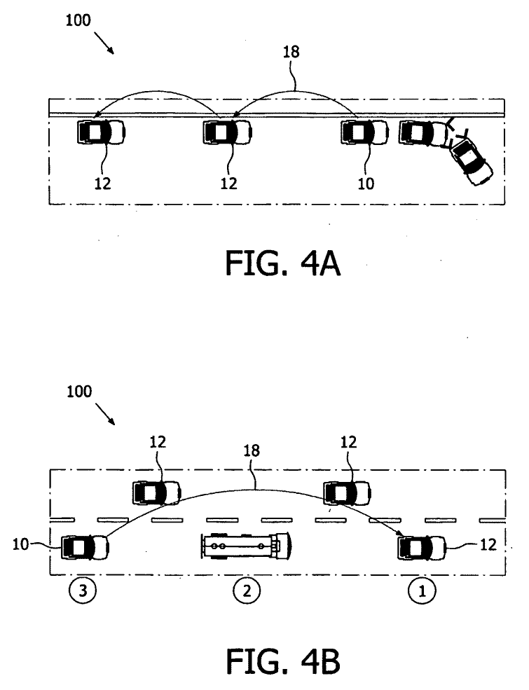

FIG. 4A schematically shows in accordance with the present invention an example of the application of inter-node (=inter-vehicular) ad-hoc communication in the case of an accident ahead;

FIG. 4B schematically shows in accordance with the present invention a further example of the application of inter-node (=inter-vehicular) ad-hoc communication in the case of an invisible obstacle; and

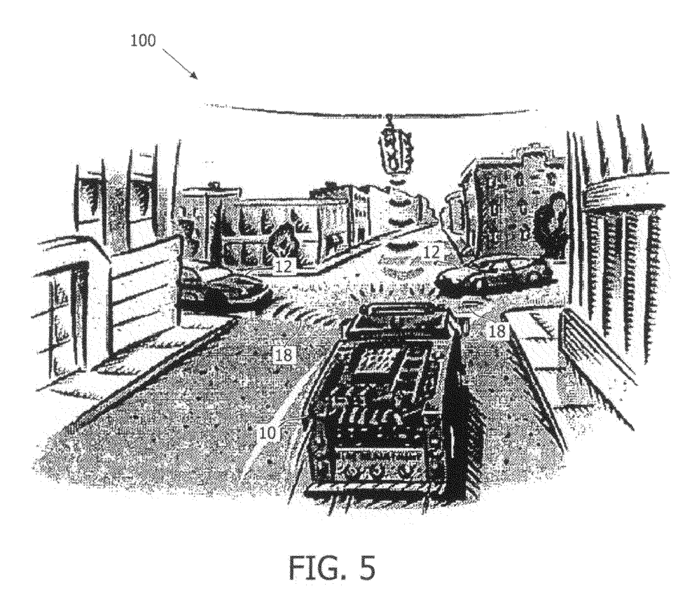

FIG. 5 perspectively shows in accordance with the present invention a further example of the application of inter-node (=inter-vehicular) ad-hoc communication in the case of a crossing or an intersection.

The same reference numerals are used for corresponding parts in FIG. 1 to FIG. 5.

In the following, an example of an arrangement for an inter-node communication system, namely a car-to-car communication system 100, according to the present invention is depicted in FIG. 1.

A group of cars, namely

a considered car (=reference node 10),

neighboring cars (=first nodes 12),

several cars (=second nodes 14) being at the central area of the group and

several cars (=third nodes 16) being at the boarder area of the group are communicating by means of a wireless ad hoc network.

As depicted in FIG. 2, each car 10, 12, 14, 16 comprises a communication system architecture with

a sender unit 20 with an antenna 22 for transmitting messages 24, 26 via a broadcast or transmission channel 18 as well as

a receptor unit 30 with an antenna 32 for sensing messages 34, 36 being sent by the neighboring cars 12, 14, 16 via the broadcast or transmission channel 18.

The main idea of the architecture of the communication system 100 is

to get information on the usage of the broadcast channel 18 by inspecting

the S[ignal]/N[oise] ratio,

the load of the broadcast channel 18 as well as

the contents and/or type of messages 34, 36 received, and

to take this information into account for scheduling transmissions of messages 24, 26.

Assuming a shared medium, the aim is to regulate the access to that medium. Instead of just sensing the medium and sending the message when the medium is available (C[arrier]S[ense]M[ultiple]A[ccess]/C[ollision]A[voidance]), it is a feature of the present invention to regulate the generation rate of the messages.

This is required because of the completely decentralized system, where certain rules are needed that every node has to obey to avoid overloading of the channel 18. In fact, in such a communication system 100, each car (=each node 10, 12, 14, 16) has to cooperate for the benefit of the whole group by actively participating to safeguard the stability and the performance of the network.

According to the system architecture as shown in FIG. 2, the process starts with the car 10 scanning the medium: a channel occupation detection unit 40 senses the broadcast or transmission channel 18 and obtains a bandwidth occupation coefficient α.

This bandwidth occupation coefficient a represents the percentage of bandwidth occupied by corrected decoded messages with respect to the system's overall bandwidth; in addition, a further coefficient dealing with the recent history of the channel occupation could be used.

The channel occupation detector 40 also furnishes another coefficient β, which indicates the general quality of the channel 18 used, expressed by the S[ignal]/N[oise] ratio (available bandwidth). This S[ignal]/N[oise] ratio can be detected by various methods, as quoted in Tero Ojanpera, “Overview of multiuser detection/interference cancellation for DS-CDMA”, EEE International Conference on Personal Wireless Communications, Dec. 17-19, 1997.

The parameters a and ,f are provided to a scheduling unit 50, which can calculate the maximum overall message rate that each node 10, 12, 14, 16 should not exceed in that channel condition.

The function of the scheduling unit 50 is to fulfill the Q[uality]o[f]S[ervice] requirements expressed in QoS requirement parameters QP, such as maximum delay, delay variance and bandwidth guarantee. The scheduler 50 has to perform this function under the condition of the calculated overall maximum message rate.

The scheduler 50 stores each message temporarily in a queue and notifies a message generating unit 60 when the message is successfully transmitted via a C[arrier]S[ense]M[ultiple]A[ccess]/C[ollision]A[voidance] device 42, or if the transmission has failed. The realization of the scheduling unit 50 can for example be weighted round robin, or any other kind of weighted fair queuing approximation.

Three different kinds of messages can be generated by a message generating unit 60: hello messages HM, warning messages WM and data messages DM. The hello messages HM and the warning messages WM are related to safety purposes, while the data messages DM can be used for more general purposes.

The overall available bandwidth for the considered node 10 has to be subdivided between these three types of messages. Such partitioning of the overall bandwidth requires more detailed information, which can be supplied from the application level. In fact, a message analyzing unit 70 can decode all the information provided by the neighboring cars 12, 14, 16 and process it to supply information, for instance on the number of detected cars in the neighborhood, to the Q[uality]o[f]S[ervice] parameter generating/regulating unit 62.

The information about the number N of neighboring cars 12, 14, 16 can be retrieved by considering the number of hello messages HM received with different identification number that have a position field that indicates that it is within a certain range, for example within a range of four hundred meters.

The information about the type of messages as transmitted by the other nodes can be understood by decoding the messages and reading the field relative to the message type. In this way, the communication system 100 can keep an updated overview of the traffic type in the channel 18.

The QoS parameter generator/regulator 62 calculates the QoS requirement parameters QP for the scheduling unit 50 based on the information it received from the message analyzer 70 and from a local situation analyzing unit 72. This local situation analyzer 72 can for example take into account the speed of the car 10: with a relatively high speed (higher than the other cars 12, 14, 16), it will be better to have a higher number of hello messages HM than with a relatively low speed.

In FIG. 2, the message generator 60 is the block that generates new messages HM, WM, DM based on the information L coming from local sensors or on the information from received messages 34, 36. This message generator 60 inserts the generated messages into three queuing lists 52, differentiated by type.

Then the scheduler 50 has the task to choose from which queuing list 52 to pick up the next message to be sent (DATA: message) to the CSMA/CA device 42 to forward it. The choice is done in order to respect (or at least not to exceed) the calculated partitioned bandwidth.

Overall available bandwidth and partitioned bandwidth have to be periodically recalculated, wherein the period should be found out by means of simulations and can also be adapted to the particular situation.

In the following, an example of the calculation of the overall bandwidth is given:

First of all, a suitable overall message rate needs to be calculated. This overall message rate has to be dependent

on the signal to noise ratio (=S/N ratio) of the broadcast or transmission channel 18 and

on the level of occupation of the broadcast or transmission channel 18 at the moment of transmission.

The overall message rate indicates in different situations what would be the maximum rate of packets (or bytes) each node 10, 12, 14, 16 could transmit, in order to avoid overloading of the channel 18. The calculation can be done with a formula similar to one of the following:

$$R = {R}_{std} + β \cdot ( {[ \frac{S}{N} ]}_{dB} - {[ \frac{S}{N} ]}_{dB ( std )} ) - α ( C - {C}_{std} )$$

$$or$$

$$R = {R}_{std} \cdot \frac{β \cdot ( {[ \frac{S}{N} ]}_{dB} - {[ \frac{S}{N} ]}_{dB ( std )} )}{α ( C - {C}_{std} )}$$

where the term α(C−C_{std}) could be substituted with the term

$${α}^{′} ( \frac{C}{{C}_{std}} )$$

if is could represent a better performing solution.
In this context,

R indicates the rate of messages that can be sent in general,

R_{std} is a standard rate calculated referring to a standard situation,

α, β are adaptive coefficients,

$${[ \frac{S}{N} ]}_{dB}$$

is the signal to noise ratio (S/N ratio) of the channel 18,

C is the level of occupation of the channel 18, and

$${[ \frac{S}{N} ]}_{dB ( std )} ,$$

C_{std} refer to the standard situation. The term

$$β \cdot ( {[ \frac{S}{N} ]}_{dB} - {[ \frac{S}{N} ]}_{dB ( std )} )$$

is added, because if the signal to noise ratio

$${[ \frac{S}{N} ]}_{dB}$$

is higher, then a higher bandwidth is available and more message can be sent, while the term α(C−C_{std}) is subtracted, because if the broadcast or transmission channel 18 is highly occupied the available bandwidth is lower, and the number of messages should be kept low to avoid overload of the broadcast or transmission channel 18.

This calculation can give the maximum rate of messages that each car 10, 12, 14, 16 should not exceed. On the other hand, this available rate should be partitioned between hello messages HM, warning messages WM and data messages DM according to the division that best fits a car-to-car communication scenario.

With respect to the partitioning of the overall bandwidth, it has to be decided in a higher layer by the Q[uality]o[f]S[ervice] parameter generating/regulating unit 62 how the available rate should be partitioned. The QoS parameter generator/regulator 62 provides the Q[uality]o[f]S[ervice] parameters to the scheduler 50. In fact, this choice implies the knowledge of more detailed parameters DP, like

the number N of cars 12, 14, 16 detected in the neighborhood,

the type of traffic already transmitted, and

other relevant local information L (sense data).

For example, the hello messages HM can be initially sent with thirty percent of the total available rate. If more cars are sensed in the neighborhood the information available in the hello message HM should be more up-to-date. The message rate for the hello messages HM could then for example be increased to fifty percent.

The communication system 100 can be implemented by using three different queuing lists 52, one for each type of message. The scheduling unit 50 chooses the queuing list 52 from which the next message is forwarded, based on the rate at which every type of message should be sent.

In this context, the calculation of the partitioning of the overall message rate between the three types is done by the scheduler 50 in dependence on the parameters α, β received from the channel occupation detector 40, and the other parameters received from the QoS parameter generating/regulating unit 62.

However, in this way less bandwidth remains available for sending warning messages WM, which is even more dangerous when many cars 10, 12, 14, 16 are nearby, because the broadcast or transmission channel 18 is loaded more heavily and the available bandwidth could become too narrow, preventing the sending of relevant information. For this reason, also a mechanism to give priority to the warning messages WM is required.

In fact, in a very dangerous situation it would be better to send warning messages WM instead of hello messages HM. In this case, the message rate for the warning messages WM should be increased at the cost of the hello messages HM.

The communication system 100 works in the following way: at first, it is assumed that there is an optimal value R_{H opt} and a safe minimum value R_{H min} for the rate of the hello messages HM as a function of the number N of neighbor cars, the speed S of the car and the overall rate R allowed: R_{H opt}=ƒ₁(N,S,R); R_{H min}=ƒ₂(N,S,R).

Then, the rate R_{W} of the allowed warning messages WM is supposed to be a function of the local information L, of the overall rate R and of the optimal rate R_{H opt} of hello messages: R_{W}=ƒ₃(L,R,R_{H opt}). When considering the local information L, the idea is to categorize and translate this local information L into parameters that can be inserted in the function ƒ₃.

Subsequently the remaining rate R_{D} can be used to transmit general data messages DM: R_{D}=R−R_{H opt}−R_{W}

This should be the normal functioning of the communication system 100. However, as stated previously, it can happen that in emergency situations some warning messages WM should be forwarded (<——>reference numeral WF in FIG. 2) even if the available rate R_{W} for the warnings is not enough.

In this case, the rate of the hello messages HM can be decreased to the minimum value R_{H min} so that R_{W} can occupy most of the available rate R. The communication system 100 can then return to the normal situation as soon as the dangerous situation has passed, and the hello message rate can go back to its optimum value R_{H opt}.

It can happen however that, if the channel 18 is heavily loaded, the available rate R_{W} for the warnings is still too low to transmit the necessary warnings, for instance due to a too low overall bandwidth R.

In this case, an external message receiver unit 54 scans the medium and sends all the messages 34, 36 correctly received to the message analyzer 70. The message analyzer 70 recognizes the type of messages 34, 36 transmitted by the other nodes 12, 14, 16.

If the message analyzer 70 finds that general data (actually, it can also be considered to interrupt warnings with low priority in addition to general data) are being transmitted, the message analyzer 70 can broadcast a “dispose bandwidth” message, asking the other nodes 12, 14, 16 to decrease the transmission of general data messages DM.

In this way, the overall occupation of the broadcast or transmission channel 18 decreases and the node 10 will regain the ability to transmit its top priority warnings. Something similar is already implemented in the W[ireless]-CH[annel-oriented]A[d-hoc]M[ulti-hop]B[roadband] protocol, called A[vailable]B[it]R[ate] Real Channel Connection Interruption Procedure (cf. Bangnan Xu, “Self-organizing wireless broadband multihop networks with QoS guarantee”, Aachener Beiträge zur Mobil-und Telekommunikation, Band 32, September 2002). However, in this prior art article it is not specified how the system can go back to its normal activity.

As a consequence, an algorithm is proposed which gradually tries to re-establish the correct bandwidth subdivision between the nodes. FIG. 3 gives a graphical explanation of this mechanism of bandwidth restoration.

The idea is to update continuously the overall bandwidth R, considering its previous value, the maximum rate at which it is allowed to send data messages DM, the real value at which the node is sending data messages DM and the presence of any “dispose bandwidth” message. So every time a “dispose bandwidth” message is received, the communication system 100 decreases its transmitting rate R, thereby diminishing its current data message rate R_{D}^{act} by a percentage defined by a parameter δ.

After this, the communication system 100 tries to recover its normal behaviour by gradually increasing its data message rate in steps defined by a parameter ε.

This can be synthesized in the following formula, as referred to also in FIG. 3: Rᵢ₊₁=Rᵢ+ε·(R_{D}−R_{D}^{act})−δ·R_{D}^{act}

Here, a discrete time system is considered: Rᵢ is the overall message rate at time t, and Rᵢ₊₁ is the overall message rate at time t+1 . δ is the parameter that indicates the amount of bandwidth the node is going to dispose (relative to the current data message rate R_{D}^{act}) due to the reception of a “dispose bandwidth!” message.

R_{D}^{act} indicates the current value of the rate for data messages DM: it is used to avoid that the overall message rate Rᵢ at time t can assume values smaller than the minimum value R_{H min} for the rate of hello messages HM or larger than the overall rate R allowed.

R_{D} indicates the rate at which the node is allowed to send general data messages DM.

The parameter ε represents the gradual increase in the overall rate that makes the node restore its normal forwarding rate. The parameters δ and ε can be calculated and changed adaptively, depending on the information about the channel occupation and on other relevant information; the respective value of the parameters δ and ε is in the range between 0 and 1.

A slightly different formula could also be applied, that results in sharper transitions: Rᵢ₊₁=Rᵢ+ε·(R−R_{H min})−δ·(R−R_{H min})=Rᵢ+(ε−δ)·(R−R_{H min})

In this latter case, a further condition has to be applied: the parameter ε has to tend to 0 when the overall message rate Rᵢ at time t is approaching the overall rate R allowed while the parameter δ has to tend to 0 when the overall message rate Rᵢ at time t is approaching the minimum value R_{H min} for the rate of hello messages HM.

The disclosure of the present invention relates in general to the field of automotive or car-to-car communication, in particular with the aim of accident-free driving, for instance with respect to traffic lighting. Thus, the present invention is relevant for I[nfra]R[ed] and R[adio]F[requency] based car-to-car communication, where sensor-equipped cars 10, 12, 14, 16 interact cooperatively to avoid collisions. In accordance therewith, the connectivity system 100 can be used for cooperative interaction of cars and for distributing in particular warning messages WM, especially

in order to avoid collisions during lane change or merge manoeuvres (cf. FIG. 1),

for reporting an accident on the lanes used (cf. FIG. 4A), and

for reporting an invisible obstacle, for example talking to (?) an obscured or shadowed object (cf. FIG. 4B), when vehicles are moving in different directions within the same area.

Apart from the applications for car-to-car communication as shown in FIG. 1, in FIG. 4A and in FIG. 4B, car-to-car communication is likewise considered crucial for intersection collision avoidance, in particular to avoid collisions when cars are entering an intersection that should be left free for a fire truck (cf. FIG. 5).

All in all, the present invention is designed to regulate the rate of messages 24, 26 sent by the nodes 10, 12, 14, 16 which constitute an ad hoc wireless network, depending on information related to the quality and usage of the transmission channel 18, which is directly sensed from the medium. This is substantial for a system that uses C[arrier]S[ense]M[ultiple]A[ccess]/C[ollision]A[voidance] access for broadcasting without any acknowledgment mechanism.

The messages are distinguished into “hello messages”, “warning messages” and “data messages”, and the overall available rate is subdivided into three different subrates, whose respective value is dependent on information retrieved from external messages and from the analyzing blocks 70, 72.

Finally, an algorithm is proposed that is able to regulate the disposal of bandwidth in case that a “dispose bandwidth” message is revealed in the channel 18; the same algorithm automatically tends to restore the normal bandwidth partition between the nodes 10, 12, 14, 16.

### LIST OF REFERENCE NUMERALS

100 communication system or arrangement for inter-node communication
10 reference node, in particular first vehicle
12 first neighboring node, in particular first neighboring vehicle
14 second neighboring node, in particular node in the central area
16 third neighboring node, in particular node in the border area
18 broadcast channel or transmission channel
20 sender unit or transmitter unit
22 antenna of the sender unit or transmitter unit 20
24 first message sent by the sender unit or transmitter unit 20 to the broadcast channel 18
26 second message sent by the sender unit or transmitter unit 20 to the broadcast channel 18
30 receptor unit or receiver unit
32 antenna of the receptor unit or receiver unit 30
34 first message arriving from the broadcast channel 18
36 second message arriving from the broadcast channel 18
40 channel occupation detection unit
42 C[arrier]S[ense]M[ultiple]A[ccess]/C[ollision]A[voidance] device
50 scheduling unit
52 queuing list
54 external message receiver unit
60 message generating unit
62 Q[uality]o[f]S[ervice] parameter generating/regulating unit
70 message analyzing unit
72 situation analyzing unit
α bandwidth occupation coefficient
β S[ignal]/N[oise] ratio coefficient
DM data message, in particular auxiliary data message
DP detailed parameter, such as number N of neighboring nodes 12, 14, 16 and/or type of traffic
δ parameter indicating the amount of bandwidth the node is going to dispose (relative to the current data message rate R_{D}^{act})
ε parameter representing the gradual increase in the overall rate
HM hello message (DATA)
L local information
MD message to be displayed
N number of neighboring nodes 12, 14, 16
QP Q[uality]o[f]S[ervice] parameters, in particular QoS requirement parameters
R maximum overall message rate
R_{D} remaining message rate
R_{D}^{act} current data message rate
R_{H min} minimum value for the hello message rate
R_{H opt} optimal value for the hello message rate
Rᵢ overall message rate at time t
R_{W} rate of allowed warning messages
S speed of the car 10, 12, 14, 16
t time
WF warning message WM to be forwarded
WM warning message (DATA)

1. Communication system for communication between and among mobile nodes in particular between and among vehicles, each node comprising
at least one sender unit for transmitting at least one message via at least one broadcast channel as well as
at least one receptor unit for sensing at least one message being sent by at least one neighboring node via the broadcast channel, characterized in that the transmission of the messages is scheduled dependent on the usage of the broadcast channel in particular dependent on
the load of the broadcast channel
the S[ignal]/N[oise] ratio on the broadcast channel and/or the contents and/or type of messages received via the broadcast channel

2. Communication system according to claim 1, characterized by at least one scheduling unit being provided by at least one channel occupation detection unit with at least one parameter, in particular
at least one bandwidth occupation coefficient (a) and/or
at least one S[ignal]/N[oise] ratio coefficient (β), said scheduling unit calculating the maximum overall message rate for each node
fulfilling the Q[uality]o[flS[ervice] requirements expressed in QoS parameters such as
maximum delay,
delay variance and/or
bandwidth guarantee,
under the condition of the calculated maximum overall message rate storing each message temporarily in at least one queuing list and
notifying at least one message generating unit
when the message is successfully transmitted via at least one
C[arrier]S[ense]M[ultiple]A[ccess]/C[ollision]A[voidance] device or
if the transmission of the message has failed.

3. Communication system according to claim 2, characterized in that
the message generating unit is designed for generating
hello messages as related to safety purposes,
warning messages as related to safety purposes and
data messages as related to general purposes, and
in that the overall available bandwidth is subdivided between these three types
of messages on the basis of information as supplied from the application level.

4. Communication system according to claim 1, characterized by at least one message analyzing unit
for decoding the messages provided by the neighboring nodes and
for processing these decoded messages to supply the information, for example about the number (N) of detected nodes in the neighborhood, to at least one Q[uality]o[flS[ervice] parameter generating/regulating unit
wherein the information about the number of detected neighboring nodes is retrievable by considering the number of hello messages received with different identification number within a certain range.

5. Communication system according to claim 4, characterized in that the QoS parameter generating regulating unit calculates the QoS requirement parameters for the scheduling unit on the basis of information received
from the message analyzing unit and
from at least one local situation analyzing unit taking into account, for example, the speed of the node.

6. Communication system according to claim 4, characterized by at least one external message receiver unit for sending the messages correctly sensed by the receptor unit to the message analyzing unit.

7. Method of communication between and among mobile nodes in particular between and among vehicles, with each node
sending at least one message via at least one broadcast channel and
receiving at least one arriving message being sent by at least one neighboring node via the broadcast channel
characterized in that the transmission of the messages is scheduled dependent on the usage of the broadcast channel in particular dependent on
the load of the broadcast channel,
the S[ignal]/N[oise] ratio on the broadcast channel and/or
the contents and/or type of messages received via the broadcast channel.

8. Method according to claim 7, characterized in that
the messages are distinguished into three different kinds of messages, called
hello messages
warning messages and
data messages and
in that the overall available message rate is subdivided into three different subrates, whose respective value is dependent on information retrieved
from external messages and
from a situation analysis.

9. Method according to claim 7, characterized
by the disposal of bandwidth being regulated in the case of revelation of at least one “dispose bandwidth” message in the broadcast channel as well as
by the normal bandwidth partition being restored between the nodes.

10. Use of at least one communication system according to and/or of the method according to claim 7 for wireless adhoc networks, in particular for automotive or car-to-car communication, wherein cars
interact cooperatively and distribute for example warning messages especially
in order to avoid collisions during lane change or merge manoeuvres and
for reporting of invisible obstacles, for example obscured or shadowed objects, when vehicles are moving in different directions within the same area.

11. Mobile node for a communication system the node comprising
at least one sender unit for transmitting at least one message via at least one broadcast channel as well as
at least one receptor unit for sensing at least one message being sent by at least one neighbouring node via the broadcast channel characterized in that the transmission of the messages is scheduled dependent on the usage of the broadcast channel in particular dependent on
the load of the broadcast channel
the S[ignal]/N[oise] ratio on the broadcast channel and/or
the contents and/or type of messages received via the broadcast channel
